(19) United States
(12) Patent Application Publication
(10) Pub. No.: US 2026/0333465 A1
(43) Pub. Date: Oct. 22, 2026

(54) SCHEDULING-BASED HIGH-PRIORITY ENHANCED DISTRIBUTED CHANNEL ACCESS

(71) Applicant: Senscomm Semiconductor Co., Ltd., Suzhou (CN)

(72) Inventors: Sung Jin PARK, Seoul (KR); DAEHONG KIM, Laguna Hills, CA (US)

(21) Appl. No.: 19/529,006

(22) Filed: Feb. 3, 2026

Related U.S. Application Data
(60) Provisional application No. 63/753,356, filed on Feb. 3, 2025.

(51) Int. Cl. H04W 74/08; H04W 74/00

(52) U.S. Cl. CPC H04W 74/0891; H04W 74/006

(57) ABSTRACT

A wireless communication device receives, from an access point (AP), a frame including information indicating a dedicated contention period during which a plurality of devices belonging to a designated device group are allowed to compete for access to a shared communication channel. If the wireless communication device belongs to the designated device group, the wireless communication device performs a contention process to obtain transmission opportunity (TXOP) during the dedicated contention period. If the wireless communication device wins the contention process during the dedicated contention period, the wireless communication device performs data transmission during the dedicated contention period.

### CROSS-REFERENCE TO RELATED APPLICATION

This application claims benefit of U.S. Provisional Application No. 63/753,356 filed on Feb.3, 2025, in the United States Patent and Trademark Office the entire contents of which are hereby incorporated by reference.

### TECHNICAL FIELD

This disclosure relates to wireless communication systems, specifically to channel access in wireless networks, and more specifically to an enhanced distributed channel access (EDCA) for high-priority traffic.

### BACKGROUND

The increasing demand for low-latency and high-throughput communication in wireless networks has led to congestion on primary Basic Service Set (BSS) channels. This congestion negatively impacts the quality of service (QoS) for applications requiring stringent latency and throughput guarantees.

In the conventional EDCA mechanism, traffic may be categorized into AC_VO (voice), AC_VI (video), AC_BE (best effort data), and AC_BK (background data), competing for channel access. However, in dense environments, even high-priority AC_VO traffic may experience significant delays due to contention with AC_BE traffic.

The description set forth in the background section should not be assumed to be prior art merely because it is set forth in the background section. The background section may describe aspects or embodiments of the present disclosure.

### SUMMARY

Some aspects of this disclosure are directed to improvements to wireless communication.

Some aspects of this disclosure are directed to scheduling-based high-priority enhanced distributed channel access (EDCA).

Some aspects of this disclosure are directed to a method for an access point (AP) to monitor the network environment in real time and schedule the application of HiP EDCA to specific Stations (STAs).

Some aspects of this disclosure are directed to a method for an Access Point (AP) to analyze network conditions and schedule HiP EDCA efficiently by considering the traffic demands of Stations (STAs).

In some embodiments, a wireless communication device may comprise processing circuitry configured to cause: receiving, from an access point (AP), a frame including information indicating a dedicated contention period during which a plurality of devices belonging to a designated device group are allowed to compete for access to a shared communication channel; based on a determination that the wireless communication device belongs to the designated device group, performing a contention process to obtain transmission opportunity (TXOP) during the dedicated contention period; and performing data transmission during the dedicated contention period based on a determination that the wireless communication device wins the contention process during the dedicated contention period.

In some embodiments, the frame further includes identifiers of a plurality of devices belonging to the designated device group.

In some embodiments, the frame further includes information indicating an interframe space which the plurality of devices belonging to the designated device group use during the dedicated contention period, and the contention process is performed based on the interframe space.

In some embodiments, the frame further includes information indicating a contention window which the plurality of devices belonging to the designated device group use during the dedicated contention period, and the contention process is performed based on the contention window.

In some embodiments, the frame further includes information indicating a limitation of the TXOP.

In some embodiments, the frame further includes information indicating a frequency band which the plurality of devices belonging to the designated device group use during the dedicated contention period, the plurality of devices belonging to the designated device group are required to switch an operating frequency band from a current frequency band to the frequency band indicated in the frame at the beginning of the dedicated contention period, and the data transmission is performed during the dedicated contention period over the frequency band indicated in the frame.

In some embodiments, the frame further includes information indicating a non-primary channel access (NPCA) primary channel which the plurality of devices belonging to the designated device group use during the dedicated contention period, the plurality of devices belonging to the designated device group are required to switch an operating channel from a basic service set (BSS) primary channel to the NPCA primary channel indicated in the frame at the beginning of the dedicated contention period, and the data transmission is performed during the dedicated contention period by using the NPCA primary channel.

In some embodiments, the information indicating the dedicated contention period includes information indicating a start time of the dedicated contention period and information indicating a duration of the dedicated contention period.

In some embodiments, the processing circuitry is further configured to cause: receiving, from the access point (AP), a request requesting a plurality of devices to send status information; and transmitting, to the AP, a response including status information of the wireless communication device in response to the request, and the plurality of devices belonging to the designated device group are determined based on the status information.

In some embodiments, the status information includes at least one of information indicating whether a device is buffering priority traffic.

In some embodiments, the processing circuitry is further configured to cause: based on a determination that the wireless communication device belongs to the designated device group, transmitting a signal to occupy the shared communication channel immediately when it detects shared communication channel as idle during the dedicated contention period, without performing backoff counting.

In some embodiments, a wireless communication device may comprise processing circuitry configured to cause: transmitting a frame including information indicating a dedicated contention period during which a plurality of devices belonging to a designated device group are allowed to compete for access to a shared communication channel; receiving data from a device which belongs to the designated device group and wins a contention process to obtain transmission opportunity (TXOP) during the dedicated contention period.

In some embodiments, the frame further includes identifiers of a plurality of devices belonging to the designated device group.

In some embodiments, the frame further includes information indicating an interframe space which the plurality of devices belonging to the designated device group use during the dedicated contention period, and the contention process is performed based on the interframe space.

In some embodiments, the frame further includes information indicating a contention window which the plurality of devices belonging to the designated device group use during the dedicated contention period, and the contention process is performed based on the contention window.

In some embodiments, the frame further includes information indicating a limitation of the TXOP.

In some embodiments, the frame further includes information indicating a frequency band which the plurality of devices belonging to the designated device group use during the dedicated contention period, the plurality of devices belonging to the designated device group are required to switch an operating frequency band from a current frequency band to the frequency band indicated in the frame at the beginning of the dedicated contention period, and the data is received during the dedicated contention period over the frequency band indicated in the frame.

In some embodiments, the frame further includes information indicating a non-primary channel access (NPCA) primary channel which the plurality of devices belonging to the designated device group use during the dedicated contention period, the plurality of devices belonging to the designated device group are required to switch an operating channel from a basic service set (BSS) primary channel to the NPCA primary channel indicated in the frame at the beginning of the dedicated contention period, and the data is received during the dedicated contention period by using the NPCA primary channel.

In some embodiments, the processing circuitry is further configured to cause: transmitting a request requesting a plurality of devices to send status information; and receiving a response including status information from at least one of devices in response to the request, and the designated device group is determined based on the status information.

In some embodiments, the status information includes at least one of information indicating whether a device is buffering traffic requiring low-latency or information indicating whether a device has experienced packet transmission failures exceeding a threshold.

By allocating a dedicated contention period to a designated device group of a plurality of wireless communication device, high-priority traffic can be transmitted more reliably in Wi-Fi environments, improving the performance of applications such as VoIP, AR/VR, and real-time streaming. Furthermore, it can ensure compatibility with the existing EDCA mechanism while optimizing overall network performance.

Some aspects of this disclosure are directed to a method for the AP to schedule HiP EDCA, allowing specific STAs to gain prioritized access to the channel. It can enhance the overall Wi-Fi network performance and ensures stable service quality even in dense environments.

### BRIEF DESCRIPTION OF THE DRAWINGS

FIG. 1 illustrates a schematic diagram of an example wireless communication network.

FIG. 2 illustrates an example of a timing diagram of interframe space (IFS) relationships between stations in accordance with an embodiment.

FIG. 3 shows an OFDM symbol and an OFDMA symbol in accordance with an embodiment.

FIG. 4A illustrates the EHT MU PPDU format in accordance with an embodiment.

FIG. 4B illustrates the EHT TB PPDU format in accordance with an embodiment.

FIG. 5 is a block diagram of an electronic device for facilitating wireless communication in accordance with an embodiment.

FIG. 6 shows a block diagram of a transmitter in accordance with an embodiment.

FIG. 7 shows a block diagram of a receiver in accordance with an embodiment.

FIG. 8 shows the MLO operation with two links in accordance with an embodiment.

FIG. 9 illustrates an example of information exchange between the AP and STAs regarding the application of HiP EDCA in accordance with an embodiment.

FIG. 10 illustrates the operation of STAs applying HiP EDCA during the active HiP EDCA contention period in accordance with an embodiment.

FIG. 11 illustrates an example of expansion of HiP EDCA to multi-link operation (MLO) and non-primary channel access (NPCA) operation in accordance with an embodiment.

FIG. 12 shows operation of an AP device and non-AP devices in accordance with an embodiment.

### DETAILED DESCRIPTION

The detailed description set forth below is intended to describe various implementations and is not intended to represent the only implementation. As those skilled in the art would realize, the described implementations may be modified in various different ways, all without departing from the scope of the present disclosure. Accordingly, the drawings and description are to be regarded as illustrative in nature and not restrictive. Like reference numerals designate like elements.

The below detailed description herein has been described with reference to a wireless LAN system according to the Institute of Electrical and Electronics Engineers (IEEE) 802.11 wireless standards including the current and future amendments. However, a person having ordinary skill in the art will readily recognize that the teachings herein are applicable to other network environments, such as cellular telecommunication networks and wired telecommunication networks.

In some embodiments, apparatus or devices such as an AP STA and a non-AP may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. The apparatus may also include one or more other hardware or software elements such as a network interface and a display device.

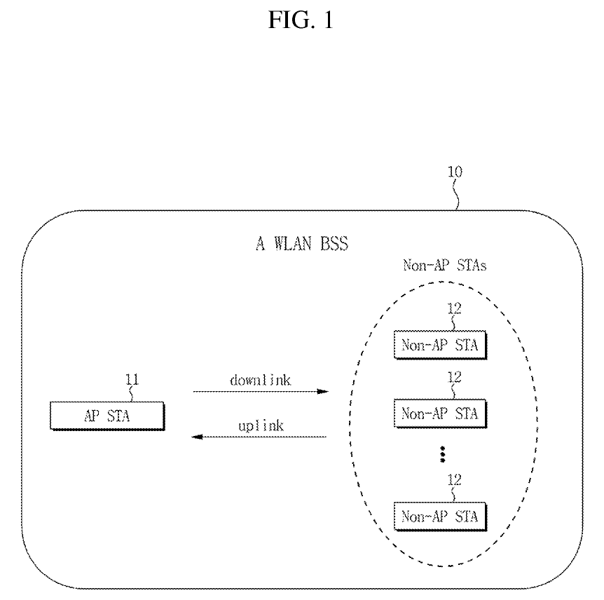

FIG. 1 illustrates a schematic diagram of an example wireless communication network.

Referring to FIG. 1, a basic service set (BSS) 10 may include a plurality of stations (STAs) including an access point (AP) station (AP STA) 11 and one or more non-AP station (non-AP STA) 12. For convenience, the non-AP STA may be referred to interchangeably as a user or an STA. The STAs may share a same radio frequency channel with one out of WLAN operation bandwidth options (e.g., 20/40/80/160/320 MHz). Hereinafter, in some embodiments, the AP STA and the non-AP STA may be referred as AP and STA, respectively. In some embodiments, the AP STA and the non-AP STA may be collectively referred as station (STA).

The plurality of STAs may participate in multi-user (MU) transmission. In the MU transmission, the AP STA 11 may simultaneously transmit the downlink (DL) frames to the multiple non-AP STAs 12 in the BSS 10 based on different resources and the multiple non-AP STAs 12 may simultaneously transmit the uplink (UL) frames to the AP STA 11 in the BSS 10 based on different resources.

For the MU transmission, multi-user multiple input, multiple output (MU-MIMO) transmission or orthogonal frequency division multiple access (OFDMA) transmission may be used. In MU-MIMO transmission, with one or more antennas, the multiple non-AP STAs 12 may either simultaneously transmit to the AP STA 11 or simultaneously receive from the AP STA 11 independent data streams over the same subcarriers. Different frequency resources may be used as the different resources in the MU-MIMO transmission. In OFDMA transmission, the multiple non-AP STAs 12 may either simultaneously transmit to the AP STA 11 or simultaneously receive from the AP STA 11 independent data streams over different groups of subcarriers. Different spatial streams may be used as the different resources in MU-MIMO transmission.

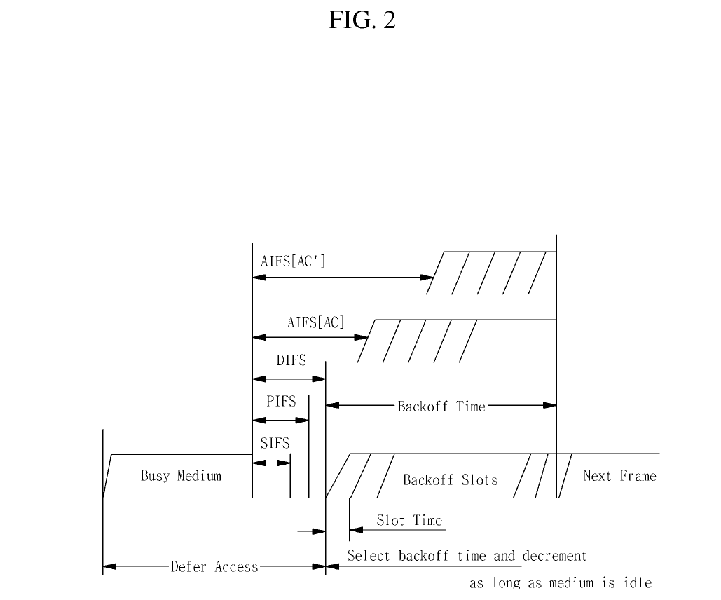

FIG. 2 illustrates an example of a timing diagram of interframe space (IFS) relationships between stations in accordance with an embodiment.

In particular, FIG. 2 shows a CSMA (carrier sense multiple access)/CA (collision avoidance) based frame transmission procedure for avoiding collision between frames in a channel.

A data frame, a control frame, or a management frame may be exchanged between STAs.

The data frame may be used for transmission of data forwarded to a higher layer. Referring to FIG. 2, access is deferred while the medium is busy until a type of IFS duration has elapsed. The STA may transmit the data frame after performing backoff if a distributed coordination function IFS (DIFS) has elapsed from a time when the medium has been idle.

The management frame may be used for exchanging management information which is not forwarded to the higher layer. Subtype frames of the management frame may include a beacon frame, an association request/response frame, a probe request/response frame, and an authentication request/response frame.

The control frame may be used for controlling access to the medium. Subtype frames of the control frame include a request to send (RTS) frame, a clear to send (CTS) frame, and an acknowledgement (ACK) frame. In the case that the control frame is not a response frame of the other frame, the STA may transmit the control frame after performing backoff if the DIFS has elapsed. If the control frame is the response frame of a previous frame, the WLAN device may transmit the control frame without performing backoff when a short IFS (SIFS) has elapsed. The type and subtype of frame may be identified by a type field and a subtype field in a frame control field.

On the other hand, a Quality of Service (QoS) STA may transmit the frame after performing backoff if an arbitration IFS (AIFS) for access category (AC), i.e., AIFS[AC] has elapsed. In this case, the data frame, the management frame, or the control frame which is not the response frame may use the AIFC[AC].

In some embodiments, a point coordination function (PCF) enabled AP STA may transmit the frame after performing backoff if a PCF IFS (PIFS) has elapsed. The PIFS duration may be less than the DIFS but greater than the SIFS.

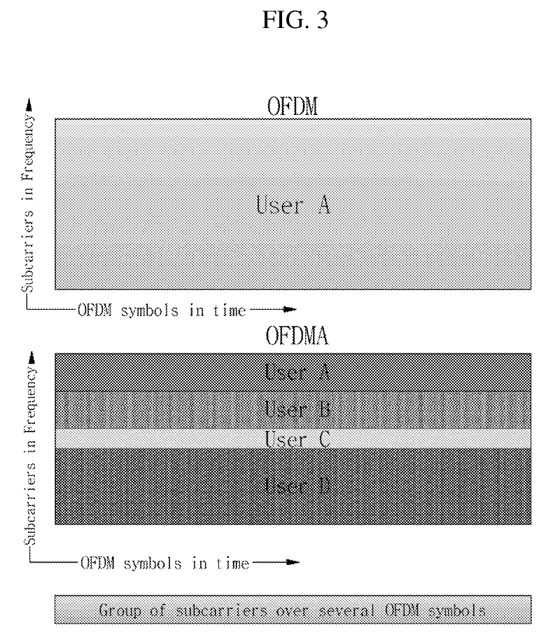

FIG. 3 shows an OFDM symbol and an OFDMA symbol in accordance with an embodiment.

For multi-user access modulation, the orthogonal frequency division multiple access (OFDMA) for uplink and downlink has been introduced in IEEE 802.11ax standard known as High Efficiency (HE) WLAN and will be used in 802.11’s future amendments such as EHT (Extreme High Throughput). One or more STAs may be allowed to use one or more resource units (RUs) throughout operation bandwidth to transmit data at the same time. As the minimum granularity, one RU may comprise a group of predefined number of subcarriers and be located at predefined location in orthogonal frequency division multiplexing (OFDM) modulation symbol. Here, non-AP STAs may be associated or non-associated with AP STA when responding simultaneously in the assigned RUs within a specific period such as a short inter frame space (SIFS). The SIFS may refer to the time duration from the end of the last symbol, or signal extension if present, of the previous frame to the beginning of the first symbol of the preamble of the subsequent frame.

The OFDMA is an OFDM-based multiple access scheme where different subsets of subcarriers may be allocated to different users, allowing simultaneous data transmission to or from one or more users with high accurate synchronization for frequency orthogonality. In OFDMA, users may be allocated different subsets of subcarriers which can change from one physical layer (PHY) protocol data unit (PPDU) to the next. In OFDMA, an OFDM symbol is constructed of subcarriers, the number of which is a function of the PPDU bandwidth. The difference between OFDM and OFDMA is illustrated in FIG. 3.

In a case of UL MU transmission, given different STAs with their own capabilities and features, the AP STA may want to have more control mechanism of the medium by using more scheduled access, which may allow more frequent use of OFDMA/MU-MIMO transmissions. PPDUs in UL MU transmission (MU-MIMO or OFDMA) may be sent as a response to the trigger frame sent by the AP. The trigger frame may have STA’s information and assign RUs and multiple RUs (MRUs) to STAs. The STA’s information in the trigger frame may comprise STA Identification (ID), MCS (modulation and coding scheme), and frame length. The trigger frame may allow an STA to transmit trigger-based (TB) PPDU (e.g., HE TB PPDU or EHT TB PPDU) which is segmented into an RU and all RUs as a response of Trigger frame are allocated to the solicited non-AP STAs accordingly. Hereafter, a single RU and a multiple RU may be referred to as the RU. The multiple RU may include, or consist of, predefined two, three, or more RUs.

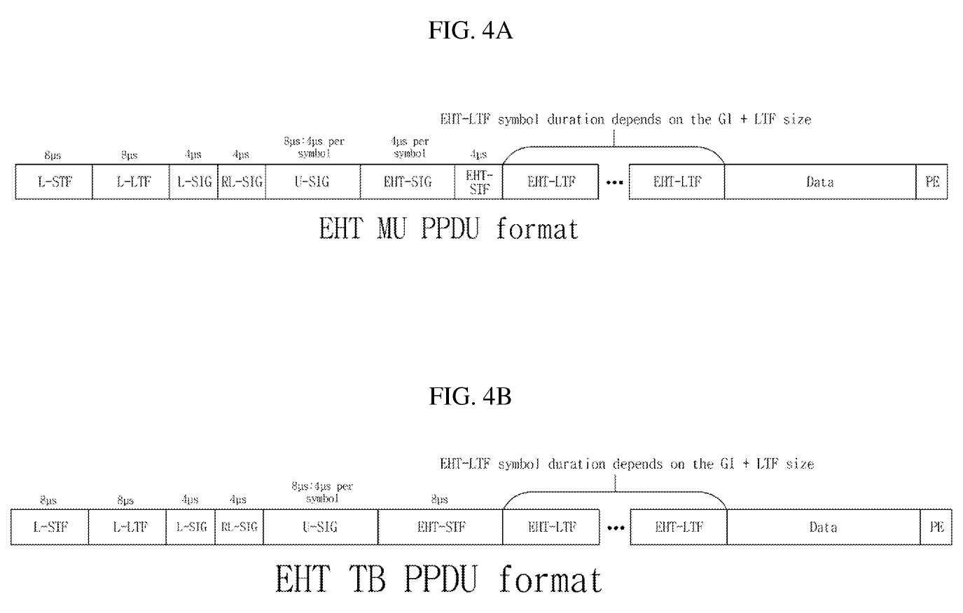

In EHT amendment, two EHT PPDU formats are defined: the EHT MU PPDU and the EHT TB PPDU. Hereinafter, the EHT MU PPDU and the EHT TB PPDU will be described with reference to FIGS. 4A and 4B .

FIG. 4A illustrates the EHT MU PPDU format in accordance with an embodiment.

The EHT MU PPDU may be used for transmission to one or more users. The EHT MU PPDU is not a response to a triggering frame.

Referring to FIG. 4A, the EHT MU PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, a universal signal (U-SIG) field, and an EHT signal (EHT-SIG) field. The EHT modulated fields may include, or consist of, an EHT short training field (EHT-STF) and an EHT long training field (EHT-LTF). In some embodiments, the L-STF may be immediately followed by the L-LTF immediately followed by the L-SIG field immediately followed by the RL-SIG field immediately followed by the U-SIG field immediately followed by the EHT-SIG field immediately followed by the EHT-STF immediately followed by the EHT-LTF immediately followed by the data field immediately followed by the PE field.

The L-STF field may be utilized for packet detection, automatic gain control (AGC), and coarse frequency-offset correction.

The L-LTF field may be utilized for channel estimation, fine frequency-offset correction, and symbol timing.

The L-SIG field may be used to communicate rate and length information.

The RL-SIG field may be a repeat of the L-SIG field and may be used to differentiate an EHT PPDU from a non-HT PPDU, HT PPDU, and VHT PPDU.

The U-SIG field may carry information necessary to interpret EHT PPDUs.

The EHT-SIG field may provide additional signaling to the U-SIG field for STAs to interpret an EHT MU PPDU. Hereinafter, the U-SIG field, the EHT-SIG field, or both may be referred to as the SIG field.

The EHT-SIG field may include one or more EHT-SIG content channel. Each of the one or more EHT-SIG content channel may include a common field and a user specific field. The common field may contain information regarding the resource unit allocation such as the RU assignment to be used in the EHT modulated fields of the PPDU, the RUs allocated for MU-MIMO and the number of users in MU-MIMO allocations. The user specific field may include one or more user fields.

The user field for a non-MU-MIMO allocation may include a STA-ID subfield, a MCS subfield, a NSS subfield, a beamformed subfield, and a coding subfield. The user field for a MU-MIMO allocation may include a STA-ID subfield, a MCS subfield, a coding subfield, and a spatial configuration subfield.

The EHT-STF field may be used to improve automatic gain control estimation in a MIMO transmission.

The EHT-LTF field may enable the receiver to estimate the MIMO channel between the set of constellation mapper outputs and the receive chains.

The data field may carry one or more physical layer convergence procedure (PLCP) service data units (PSDUs).

The PE field may provide additional receive processing time at the end of the EHT MU PPDU.

FIG. 4B illustrates the EHT TB PPDU format in accordance with an embodiment.

The EHT TB PPUD may be used for a transmission of a response to a triggering frame.

Referring to FIG. 4B, the EHT TB PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, and a universal signal (U-SIG) field. The EHT modulated fields may include, or consist of, an EHT short training field (EHT-STF) and an EHT long training field (EHT-LTF). In some embodiments, the L-STF may be immediately followed by the L-LTF immediately followed by the L-SIG field immediately followed by the RL-SIG field immediately followed by the U-SIG field immediately followed by the EHT-STF immediately followed by the EHT-LTF immediately followed by the data field immediately followed by the PE field. In the EHT TB PPUD, the EHT-SIG field is not present because the trigger frame conveys necessary information and the duration of the EHT_STF field in the EHT TB PPUD is twice the duration of the EHT-STF field in the EHT MU PPDU.

Description for each field in the EHT TB PPDU will be omitted because description for each field in the EHT MU PPDU is applicable to the EHT TB PPDU.

For EHT MU PPDU and EHT TB PPUD, when the EHT modulated fields occupy more than one 20 MHz channels, the pre-EHT modulated fields may be duplicated over multiple 20 MHz channels.

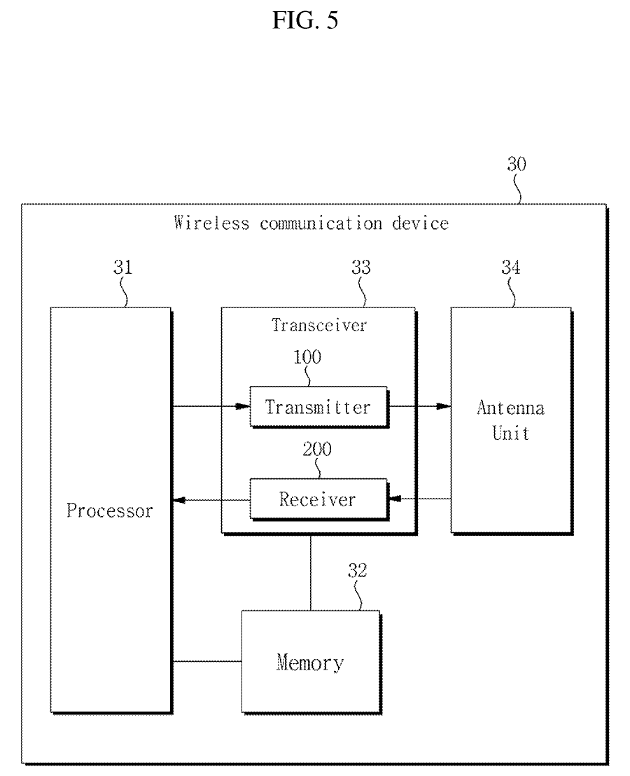

Hereinafter, electronic devices for facilitating wireless communication in accordance with various embodiments will be described with reference to FIG. 5.

FIG. 5 is a block diagram of an electronic device for facilitating wireless communication in accordance with an embodiment.

Referring to FIG. 5, an electronic device 30 for facilitating wireless communication in accordance with an embodiment may include a processor 31, a memory 32, a transceiver 33, and an antenna unit 34. The transceiver 33 may include a transmitter 100 and a receiver 200.

The processor 31 may perform medium access control (MAC) functions, PHY functions, RF functions, or a combination of some or all of the foregoing. In some embodiments, the processor 31 may comprise some or all of a transmitter 100 and a receiver 200. The processor 31 may be directly or indirectly coupled to the memory 32. In some embodiments, the processor 31 may include one or more processors.

The memory 32 may be non-transitory computer-readable recording medium storing instructions that, when executed by the processor 31, cause the electronic device 30 to perform operations, methods or procedures set forth in the present disclosure. In some embodiments, the memory 32 may store instructions that are needed by one or more of the processor 31, the transceiver 33, and other components of the electronic device 30. The memory may further store an operating system and applications. The memory 32 may comprise, be implemented as, or be included in a read-and-write memory, a read-only memory, a volatile memory, a non-volatile memory, or a combination of some or all of the foregoing.

The antenna unit 34 includes one or more physical antennas. When multiple-input multiple-output (MIMO) or multi-user MIMO (MU-MIMO) is used, the antenna unit 34 may include more than one physical antennas.

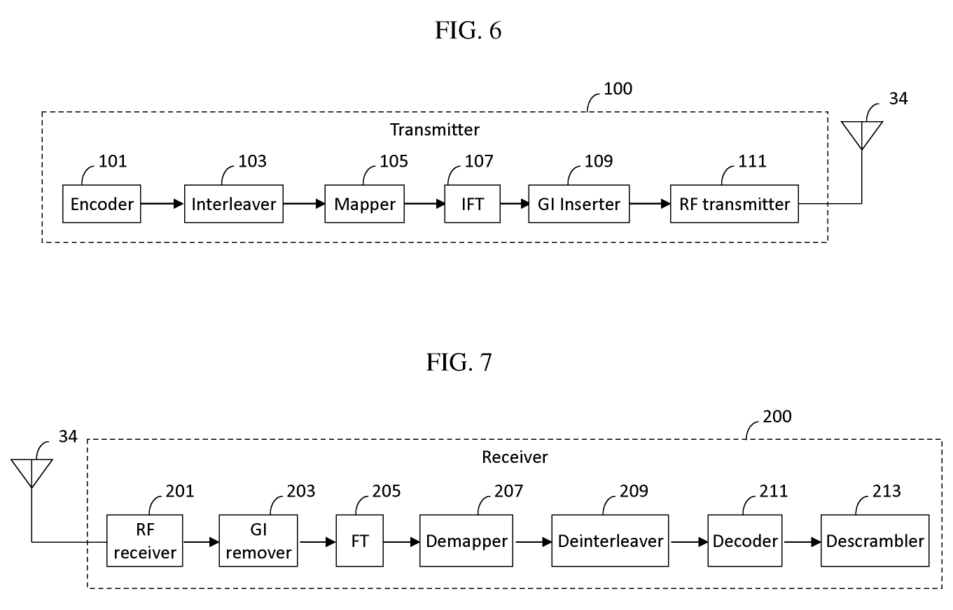

FIG. 6 shows a block diagram of a transmitter in accordance with an embodiment.

Referring to FIG. 7, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder.

The interleaver 103 may interleave bits of encoded data from the encoder 101 to change the order of bits, and output interleaved data. In some embodiments, interleaving may be applied when BCC encoding is employed.

The mapper 105 may map interleaved data into constellation points to generate a block of constellation points. If the LDPC encoding is used in the encoder 101, the mapper 105 may further perform LDPC tone mapping instead of the constellation mapping.

The IFT 107 may convert the block of constellation points into a time domain block corresponding to a symbol by using an inverse discrete Fourier transform (IDFT) or an inverse fast Fourier transform (IFFT).

The GI inserter 109 may prepend a GI to the symbol.

The RF transmitter 111 may convert the symbols into an RF signal and transmits the RF signal via the antenna unit 34.

FIG. 7 shows a block diagram of a receiver in accordance with an embodiment.

Referring to FIG. 7, the receiver 200 in accordance with an embodiment may include a RF receiver 201, a GI remover 203, a Fourier transformer (FT) 205, a demapper 207, a deinterleaver 209, and a decoder 211.

The RF receiver 201 may receive an RF signal via the antenna unit 34 and converts the RF signal into one or more symbols.

The GI remover 203 may remove the GI from the symbol.

The FT 205 may convert the symbol corresponding a time domain block into a block of constellation points by using a discrete Fourier transform (DFT) or a fast Fourier transform (FFT) depending on implementation.

The demapper 207 may demap the block of constellation points to demapped data bits. If the LDPC encoding is used, the demapper 207 may further perform LDPC tone demapping before the constellation demapping.

The deinterleaver 209 may deinterleave demapped data bits to generate deinterleaved data bits. In some embodiments, deinterleaving may be applied when BCC encoding is used.

The decoder 211 may decode the deinterleaved data bits to generate decoded bits. For example, the decoder 211 may be an FEC decoder. The FEC decoder may include a BCC decoder or an LDPC decoder. In order to support the HARQ procedure, the decoder 211 may combine a retransmitted data with an initial data.

The descrambler 213 may descramble the descrambled data bits based on a scrambler seed.

Hereinafter, a multi-link operation (MLO) in accordance with an embodiment will be described.

The IEEE 802.11be Extremely High Throughput (EHT) task group is currently developing the next generation Wi-Fi standard to achieve higher data rate, lower latency, and more reliable connection to enhance user experience. One of the key features of the IEEE 802.11be standard is a multi-link operation (MLO). As most of the AP STAs and the non-AP STAs incorporate dual-band or tri-band capabilities, the newly developed MLO feature may enable packet-level link aggregation in the MAC layer across different PHY links. By performing load balancing according to traffic requirements, the MLO may achieve significantly higher throughput and lower latency for enhanced reliability in a heavily loaded network. With the MLO capability, a multi-link device (MLD) includes multiple affiliated devices to the upper logical link control (LLC) layer, allowing concurrent data transmission and reception in multiple channels across a single or multiple frequency bands in 2.4GHz, 5GHz and 6GHz.

There exists Wi-Fi technologies that allow a Wi-Fi device to connect to a single link and enable the Wi-Fi device to switch among 2.4GHz, 5GHz and 6GHz bands. However, such Wi-Fi devices typically have a switching overhead or delay of up to 100ms. Therefore, the MLO is highly desirable for real-time applications like video calls, wireless VR headsets, cloud gaming and other latency-sensitive applications. The IEEE 802.11be draft specification defines different channel access methods according to two transmission modes: asynchronous and synchronous modes. Under asynchronous transmission mode, the MLD transmits frames asynchronously across multiple links without aligning the starting time. In contrast, in synchronous transmission mode, the starting times are aligned across the links. In either mode, the links may have their own primary channel and parameters, including Packet Protocol Data Unit (PPDU), Modulation and Coding Scheme (MCS), Enhanced Distributed Channel Access (EDCA), etc.

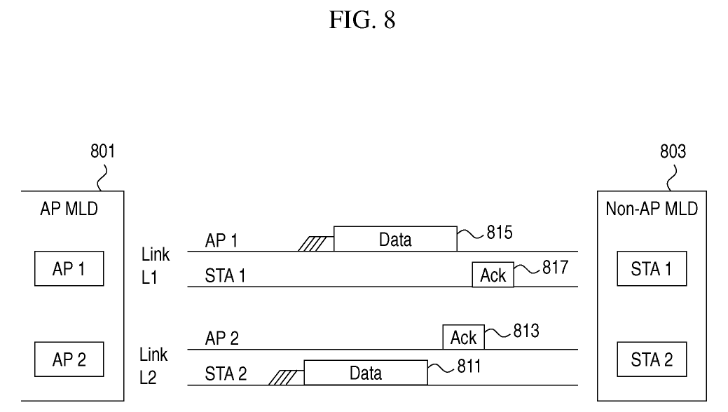

Hereinafter, a Multi-link Operation (MLO) will be described with reference to FIG. 8.

FIG. 8 shows the MLO operation with two links in accordance with an embodiment.

Referring to FIG. 8, the AP MLD 801 may comprise a plurality of APs including AP 1 and AP 2, and the non-AP MLD may comprise a plurality of STAs including STA 1 and STA 2. The AP 1 may have a buffer containing data units including data units to be transmitted to the STA 1, the AP 2 may have a buffer containing data units including data units to be transmitted to the STA 2, the STA 1 may have a buffer containing data units including data units to be transmitted to the AP 1, and the STA 2 may have a buffer containing data units including data units to be transmitted to the AP 2.

The STA 2 of the non-AP MLD 803 may check whether a backoff counter for the link L2 reaches 0. When the backoff counter for the link L2 reaches 0, the STA 2 of the non-AP MLD 803 may transmit the data unit 811 to the AP 2 via the link L2. The AP 2 of the AP MLD 801 may transmit an Ack frame 813 for the data unit 811 to the STA 2 via the link L2 a SIFS after the AP 2 successfully receives the data unit 811.

Even during the AP 2’s reception of the data unit 811, the AP 1 of the AP MLD 801 may check whether a backoff counter for the link L1 reaches 0. When the backoff counter for the link L1 reaches 0, the AP 1 of the AP MLD 801 may transmit the data unit 815 to the STA 1 via the link L1 even during the AP 2’s reception of the data unit 811. The STA 1 of the non-AP MLD 803 may transmit an Ack frame 817 for the data unit 815 to the AP 1 via link L1 a SIFS after the STA 1 successfully receives the data unit 815.

In the embodiment of FIG. 8, the AP MLD 801 may complete receiving the data unit 811 via the link L2 first, and then the non-AP MLD 803 may complete receiving the data unit 815 via the link L1.

In the conventional EDCA mechanism, traffic may be categorized into AC_VO (voice), AC_VI (video), AC_BE (best effort data), and AC_BK (background data), competing for channel access. However, in dense environments, even high-priority AC_VO traffic may experience significant delays due to contention with AC_BE traffic.

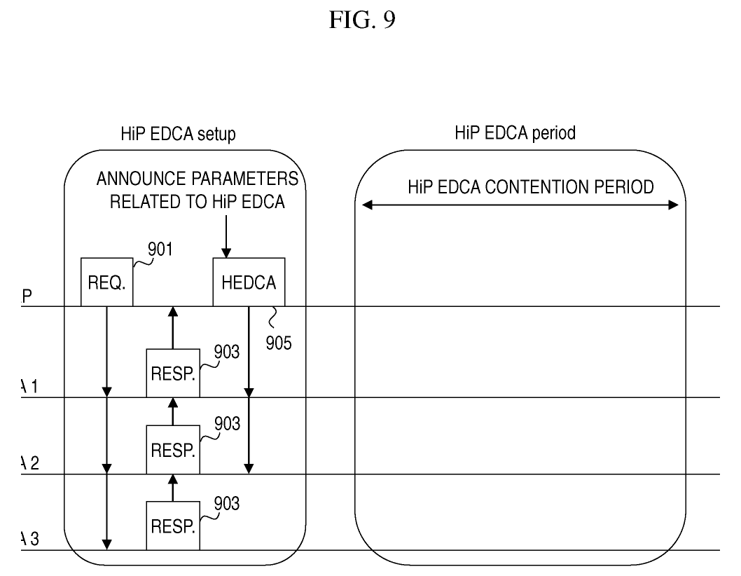

Hereinafter, STA selection and priority assignment in accordance with an embodiment will be described with reference to FIG. 9.

FIG. 9 illustrates an example of information exchange between the AP and STAs regarding the application of HiP EDCA in accordance with an embodiment.

The AP may analyze network traffic patterns to identify STAs that require HiP EDCA. In some embodiments, STAs that buffer low-latency traffic requiring low-latency may be classified as HiP EDCA-eligible STAs. For example, traffic for applications such as VoIP, real-time streaming, and AR/VR may be the low-latency traffic. In some embodiments, STAs that have experienced a certain number of packet transmission failures under conventional EDCA may be classified as HiP EDCA-eligible STAs. In some embodiments, STAs requiring guaranteed low latency through Service Coordination Signaling (SCS) may be classified as HiP EDCA-eligible STAs. These STAs may be granted faster and more frequent channel access opportunities. In some embodiments, at least one of STAs that buffer low-latency traffic, STAs that have experienced a certain number of packet transmission failures, or STAs requiring guaranteed low latency through Service Coordination Signaling (SCS) may be classified as HiP EDCA-eligible STAs. For convenience, low-latency traffic requiring low-latency, traffic that have experienced a certain number of packet transmission failures under conventional EDCA, and traffic requiring guaranteed low latency through Service Coordination Signaling (SCS) may be referred to as high priority traffic or priority traffic.

In order to identify STAs that require HiP EDCA, the AP may transmit a request frame 901 to determine which STAs require HiP EDCA. In some embodiments, the request frame 901 may ask for whether an STA is buffering low-latency traffic, has experienced a certain number of packet transmission failures exceeding a threshold under conventional EDCA, or requires guaranteed low latency through Service Coordination Signaling (SCS).

Upon receiving the request frame 901 from the AP, STAs may respond by transmitting a response frame 903, informing the AP about their needs for HiP EDCA. In some embodiments, the response frame 903 may include information indicating whether an STA is buffering low-latency traffic, has experienced a certain number of packet transmission failures under conventional EDCA, or requires guaranteed low latency through Service Coordination Signaling (SCS).

Based on the received response frames 903, the AP may identify the STAs eligible for HiP EDCA and transmits the HEDCA frame exclusively to the identified STAs.

As shown in FIG. 9, the AP may transmit the HEDCA frame 905 only to STA 1 and STA 2 which have been identified as requiring HiP EDCA, to announce the application of HiP EDCA for a specific period within its BSS. The specific period dedicated to stations identified as requiring HiP EDCA may be referred to as an HiP EDCA contention period.

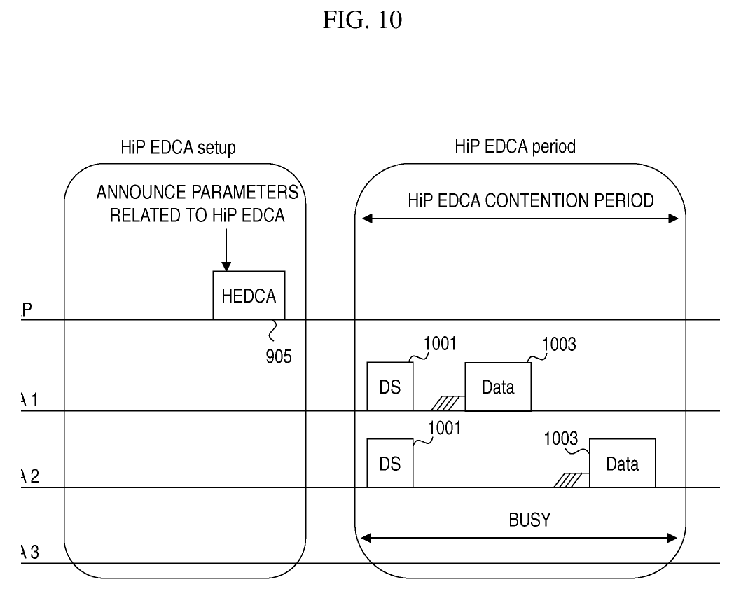

Hereinafter, HiP EDCA activation based on a defer signal (DS) in accordance with an embodiment will be described with reference to FIG. 10.

FIG. 10 illustrates the operation of STAs applying HiP EDCA during the active HiP EDCA contention period in accordance with an embodiment.

The AP may announce the application of HiP EDCA for a specific period within its BSS through a management frame, such as a beacon or probe response. This management frame may be referred to as the HEDCA frame. The AP may transmit the HEDCA frame 905 to STAs which have been identified as requiring HiP EDCA. Referring to FIG. 10, since STA 1 and STA 2 have been identified for HiP EDCA, the AP may transmit the HEDCA frame 905 to STA 1 and STA 2, and STA 1 and STA 2 may receive the HEDCA frame 905 from the AP.

In some embodiments, the HEDCA frame 905 may include the AID or MAC addresses of STAs eligible for HiP EDCA. Referring to FIG. 10, since STA 1 and STA 2 have been identified for HiP EDCA, the HEDCA frame 905 may include the AID or MAC addresses of STA 1 and STA 2, which are eligible for HiP EDCA.

In some embodiments, the HEDCA frame 905 may include information indicating the HiP EDCA contention period. For example, the HEDCA frame 905 may include information indicating a start time of the HiP EDCA contention period and information indicating a duration of the HiP EDCA contention period.

In some embodiments, the AP may grant transmission permission of defer signals (DS) 1001 to the identified STAs, allowing them to access the channel with priority. During the HiP EDCA contention period, an STA utilizing HiP EDCA may transmit a DS signal 1001 to occupy the channel immediately when it detects the channel as idle, without performing backoff counting. In some embodiments, the DS signal 1001 can be an RTS (request to send) or CTS (clear to send) frame, modified to facilitate HiP EDCA. This can enable the STA to seize the channel before other contenders. Referring to FIG. 10, if STA 3 which has not been identified for HiP EDCA receives the DS signal 1001, it may determine that the channel is busy and may determine not to participate in the contention during the HiP EDCA period.

In some embodiments, only STAs that have transmitted a DS signal 1001 may be allowed to participate in the HiP EDCA contention. In some embodiments, STAs that have not sent a DS signal 1001 may be excluded and abstain from contention during the HiP EDCA contention period.

In some embodiments, STAs engaging in HiP EDCA contention may set a shorter backoff duration than the conventional EDCA backoff, minimizing transmission latency.

STA 1 and STA 2, which transmitted the DS signal 1001, may proceed with the contention process under HiP EDCA. The STA that successfully wins the contention may gain control of the channel and transmit its data traffic 1003.

In some embodiments, the AP may adjust the AIFSN and the contention window (CW) value for the contention process. In some embodiments, the AP may set the AIFSN (Arbitration Inter-Frame Space Number) value of STAs using HiP EDCA to 2 (DIFS) or lower to ensure faster channel access. In some embodiments, the AP may dynamically adjust the contention window (CW) value to prevent excessive collisions that may occur if the CW value is too small. In some embodiments, the dynamically adjusted AIFSN and CW values may be communicated to the STAs through the HEDCA frame 905. In some embodiments, the HEDCA frame 905 may include indications of AIFSN value and CW value to adjust HiP EDCA parameters dynamically.

In some embodiments, the AIFS may be used by QoS STAs that access the medium using the EDCAF to transmit data frames. A STA using the EDCAF may obtain a transmission opportunity (TXOP) for the HiP EDCA if the STA’s CS mechanism determines that the medium is idle at the AIFS slot boundary, after a correctly received frame, and the backoff counter for the HiP EDCA has a value of zero.

The EDCAF may maintain a backoff counter, which has a value measured in backoff slots. When the backoff procedure is invoked, the backoff counter may be set to an integer value chosen randomly with a uniform distribution taking values in the range 0 to CW for the HiP EDCA. In some embodiments, the duration AIFS for the HiP EDCA may be a duration derived from the value AIFSN for the high priority traffic by the relation AIFS = AIFSN × aSlotTime + aSIFSTime.

In some embodiments, the TXOP may be limited for channel occupancy optimization. For example, the AP may set a TXOP limit to prevent STAs using HiP EDCA from excessively occupying the channel. If STAs utilizing HiP EDCA are granted excessive transmission opportunities, it may cause latency issues for STAs using conventional EDCA without HiP EDCA. Therefore, the AP may regulate TXOP duration to maintain a balanced channel access environment. In some embodiments, the HEDCA frame 905 may include indications of TXOP limitation to optimize channel utilization.

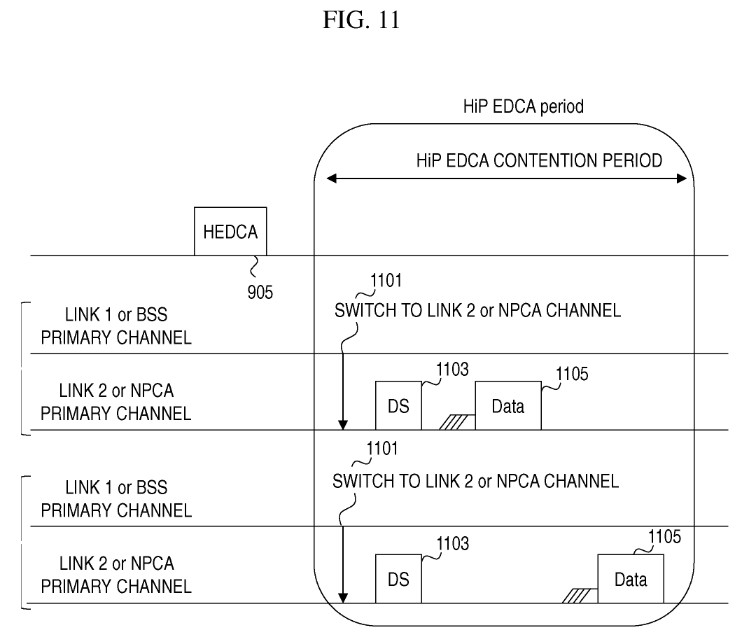

Hereinafter, the expansion of the HiP EDCA contention period to multi-link operation (MLO) and non-primary channel access (NPCA) operation in accordance with an embodiment will be described with reference to FIG. 11.

FIG. 11 illustrates an example of expansion of HiP EDCA to multi-link operation (MLO) and non-primary channel access (NPCA) operation in accordance with an embodiment.

To prevent allocation of the HiP EDCA contention period from affecting legacy STAs or STAs using conventional EDCA, the AP may enable HiP EDCA on a different link or on an NPCA primary channel.

The HEDCA frame 905 transmitted by the AP may include information about the link or channel to which the HiP EDCA is applied. STAs that receive the HEDCA frame 905 may switch to the specified link or channel as indicated in the frame and use HiP EDCA to transmit traffic.

STA 1 and STA 2, which have been identified as eligible for HiP EDCA, receive the HEDCA frame 905. When the HiP EDCA period begins, STA 1 and STA 2 may switch to the other link or NPCA channel specified in the HEDCA frame 905 at 1101 and apply HiP EDCA. Referring to FIG. 11, STA 1 and STA 2 may switch to the link 2 or the NPCA primary channel.

In some embodiments, the identified STA may transmit the defer signals 1103 to occupy the channel immediately when it detects the channel as idle, without performing backoff counting. In some embodiments, if all STAs on the switched link or NPCA channel are HiP EDCA-enabled, transmission of the DS signal may not be necessary. STA 1 and STA 2 which are identified as eligible for HiP EDCA may proceed with the contention process under HiP EDCA. The STA that successfully wins the contention may gain control of the channel and transmit its data traffic 1105.

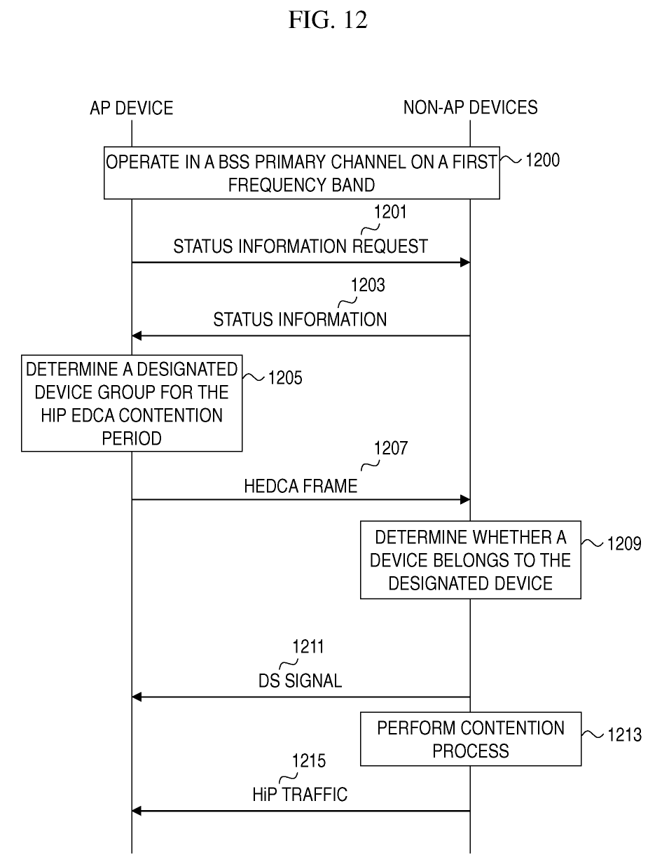

FIG. 12 shows operation of an AP device and non-AP devices in accordance with an embodiment.

Referring to FIG. 12, the AP device and one or more non-AP devices may operate in a BSS primary channel on a first frequency band at 1200.

In some embodiments, the AP device may have one or more AP stations performing communication over one or more links using different channels on different frequency bands or the same frequency band. For example, the AP device may have a first AP station performing communication over a first link and a second AP station performing communication over a second link. The first and second links may use different channels on different frequency bands or the same frequency band.

In some embodiments, the respective one non-AP device of the one or more non-AP devices may have one or more non-AP stations performing communication over one or more links using different channels on different frequency bands or the same frequency band. For example, the non-AP device may have a first non-AP station performing communication over a first link and a second non-AP station performing communication over a second link. The first and second links may use different channels on different frequency bands or the same frequency band.

At 1201, the AP device may transmit a status information request frame to a plurality of non-AP devices. In some embodiments, the status information request frame may include a status information request requesting a plurality of non-AP devices to send their status information to the AP device. In some embodiments, the status information includes at least one of information indicating whether a device is buffering high priority traffic.

At 1203, at least one of the plurality of non-AP devices may transmit a status information frame including status information to the AP device in response to the status information request frame. In some embodiments, the status information includes at least one of information indicating whether a device is buffering high priority traffic.

At 1205, based on status information from the at least one of the plurality of non-AP devices, the AP device may determine a group of non-AP devices designated for a HiP EDCA contention period during which a plurality of devices belonging to the designated device group are allowed to compete for access to a shared communication channel. In some embodiments, the HiP EDCA contention period may be dedicated to non-AP devices belonging to the designated device group.

In some embodiments, based on status information from the at least one of the plurality of non-AP devices, the AP device may determine the HiP EDCA contention period. In some embodiments, based on status information from the at least one of the plurality of non-AP devices, the AP device may determine a start time and a duration of the HiP EDCA contention period.

At 1207, the AP device may transmit an HEDCA frame including information indicating the HiP EDCA contention period during which a plurality of devices belonging to the designated device group are allowed to compete for access to a shared communication channel.

In some embodiments, the information indicating the HiP EDCA contention period may include information indicating a start time of the HiP EDCA contention period and information indicating a duration of the HiP EDCA contention period.

In some embodiments, the HEDCA frame may include identifiers of a plurality of devices belonging to the designated device group.

In some embodiments, the HEDCA frame may include information indicating an interframe space which the plurality of devices belonging to the designated device group use during the HiP EDCA contention period. In some embodiments, the information indicating an interframe space may be AIFSN.

In some embodiments, the HEDCA frame may include information indicating a contention window which the plurality of devices belonging to the designated device group use during the HiP EDCA contention period.

In some embodiments, the HEDCA frame further includes information indicating a limitation of the TXOP.

In some embodiments, the HEDCA the frame may include information indicating a frequency band which the plurality of devices belonging to the designated device group use during the HiP EDCA contention period.

In some embodiments, the HEDCA frame may include information indicating a non-primary channel access (NPCA) primary channel which the plurality of devices belonging to the designated device group use during the HiP EDCA contention period.

At 1209, if non-AP devices receive the HEDCA frame, the non-AP devices may determine that they belong to the designated device group.

At 1211, the non-AP device belongs to the designated device group may transmit a defer signal to occupy the shared communication channel immediately when they detect shared communication channel as idle during the HiP EDCA contention period, without performing backoff counting.

At 1213, the non-AP devices belonging to the designated device group may perform a contention process to obtain transmission opportunity (TXOP) during the HiP EDCA contention period.

In some embodiments, the non-AP devices belonging to the designated device group may perform the contention process during the HiP EDCA contention period based on the interframe space and the contention window indicated in the HEDCA frame. In some embodiments, the interframe space may be AIFS indicated by AIFSN of the HEDCA frame.

At 1215, if a non-AP device wins the contention during the HiP EDCA contention period, the non-AP device may transmit a data frame including high priority traffic during the HiP EDCA contention period.

In some embodiments, non-AP devices belonging to the designated device group may be required to switch an operating channel from the basic service set (BSS) primary channel to the NPCA primary channel indicated in the HEDCA frame at the beginning of the HiP EDCA contention period.

In some embodiments, the non-AP device acquiring the TXOP may transmit a data frame including high priority traffic during the HiP EDCA contention period by using the NPCA primary channel.

In some embodiments, non-AP devices belonging to the designated device group may be required to switch an operating frequency band from the first frequency band to the second frequency band indicated in the HEDCA frame at the beginning of the HiP EDCA contention period.

In some embodiments, the non-AP device acquiring the TXOP may transmit a data frame including high priority traffic during the HiP EDCA contention period over the second frequency band indicated in the HEDCA frame.

The various illustrative blocks, units, modules, components, methods, operations, instructions, items, and algorithms may be implemented or performed with a processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A wireless communication device, comprising processing circuitry configured to cause:
receiving, from an access point (AP), a frame including information indicating a dedicated contention period during which a plurality of devices belonging to a designated device group are allowed to compete for access to a shared communication channel;
based on a determination that the wireless communication device belongs to the designated device group, performing a contention process to obtain transmission opportunity (TXOP) during the dedicated contention period; and
performing data transmission during the dedicated contention period based on a determination that the wireless communication device wins the contention process during the dedicated contention period.

2. The wireless communication device of claim 1, wherein the frame further includes identifiers of a plurality of devices belonging to the designated device group.

3. The wireless communication device of claim 1, wherein the frame further includes information indicating an interframe space which the plurality of devices belonging to the designated device group use during the dedicated contention period, and
wherein the contention process is performed based on the interframe space.

4. The wireless communication device of claim 1, wherein the frame further includes information indicating a contention window which the plurality of devices belonging to the designated device group use during the dedicated contention period, and
wherein the contention process is performed based on the contention window.

5. The wireless communication device of claim 1, wherein the frame further includes information indicating a limitation of the TXOP.

6. The wireless communication device of claim 1, wherein the frame further includes information indicating a frequency band which the plurality of devices belonging to the designated device group use during the dedicated contention period,
wherein the plurality of devices belonging to the designated device group are required to switch an operating frequency band from a current frequency band to the frequency band indicated in the frame at the beginning of the dedicated contention period,
wherein the data transmission is performed during the dedicated contention period over the frequency band indicated in the frame.

7. The wireless communication device of claim 1, wherein the frame further includes information indicating a non-primary channel access (NPCA) primary channel which the plurality of devices belonging to the designated device group use during the dedicated contention period,
wherein the plurality of devices belonging to the designated device group are required to switch an operating channel from a basic service set (BSS) primary channel to the NPCA primary channel indicated in the frame at the beginning of the dedicated contention period,
wherein the data transmission is performed during the dedicated contention period by using the NPCA primary channel.

8. The wireless communication device of claim 1, wherein the information indicating the dedicated contention period includes information indicating a start time of the dedicated contention period and information indicating a duration of the dedicated contention period.

9. The wireless communication device of claim 1, wherein the processing circuitry is further configured to cause:
receiving, from the access point (AP), a request requesting a plurality of devices to send status information; and
transmitting, to the AP, a response including status information of the wireless communication device in response to the request, and
wherein the plurality of devices belonging to the designated device group are determined based on the status information.

10. The wireless communication device of claim 9, wherein the status information includes at least one of information indicating whether a device is buffering priority traffic.

11. The wireless communication device of claim 1, wherein the processing circuitry is further configured to cause:
based on a determination that the wireless communication device belongs to the designated device group, transmitting a signal to occupy the shared communication channel immediately when it detects shared communication channel as idle during the dedicated contention period, without performing backoff counting.

12. A wireless communication device, comprising processing circuitry configured to cause:
transmitting a frame including information indicating a dedicated contention period during which a plurality of devices belonging to a designated device group are allowed to compete for access to a shared communication channel;
receiving data from a device which belongs to the designated device group and wins a contention process to obtain transmission opportunity (TXOP) during the dedicated contention period.

13. The wireless communication device of claim 12, wherein the frame further includes identifiers of a plurality of devices belonging to the designated device group.

14. The wireless communication device of claim 12, wherein the frame further includes information indicating an interframe space which the plurality of devices belonging to the designated device group use during the dedicated contention period, and
wherein the contention process is performed based on the interframe space.

15. The wireless communication device of claim 12, wherein the frame further includes information indicating a contention window which the plurality of devices belonging to the designated device group use during the dedicated contention period, and
wherein the contention process is performed based on the contention window.

16. The wireless communication device of claim 12, wherein the frame further includes information indicating a limitation of the TXOP.

17. The wireless communication device of claim 12, wherein the frame further includes information indicating a frequency band which the plurality of devices belonging to the designated device group use during the dedicated contention period,
wherein the plurality of devices belonging to the designated device group are required to switch an operating frequency band from a current frequency band to the frequency band indicated in the frame at the beginning of the dedicated contention period,
wherein the data is received during the dedicated contention period over the frequency band indicated in the frame.

18. The wireless communication device of claim 12, wherein the frame further includes information indicating a non-primary channel access (NPCA) primary channel which the plurality of devices belonging to the designated device group use during the dedicated contention period,
wherein the plurality of devices belonging to the designated device group are required to switch an operating channel from a basic service set (BSS) primary channel to the NPCA primary channel indicated in the frame at the beginning of the dedicated contention period,
wherein the data is received during the dedicated contention period by using the NPCA primary channel.

19. The wireless communication device of claim 12, wherein the processing circuitry is further configured to cause:
transmitting a request requesting a plurality of devices to send status information; and
receiving a response including status information from at least one of devices in response to the request,
wherein the designated device group is determined based on the status information.

20. The wireless communication device of claim 12, wherein the status information includes at least one of information indicating whether a device is buffering traffic requiring low-latency or information indicating whether a device has experienced packet transmission failures exceeding a threshold.
